(19) United States
(12) Patent Application Publication
(10) Pub. No.: US 2008/0193771 A1
(43) Pub. Date: Aug. 14, 2008

(54) Method of Preventing or Reducing Temperature Gradient Caused Bending of a Structural Element

(75) Inventors: Anders Korsgaard, Christiansfeld (DK); Henrik Thorning, Kolding (DK)

Correspondence Address: KLEIN, O'NEILL & SINGH, LLP, 43 CORPORATE PARK, SUITE 204, IRVINE, CA, 92606, US

(73) Assignee: Fiberline A/S, Kolding (DK)

(21) Appl. No.: 10/591,495

(22) PCT Filed: Mar. 4, 2005
(86) PCT No.: PCT/DK05/00148

§ 371 Date: May 15, 2007

(30) Foreign Application Priority Data
Mar. 4, 2004 (DK) PA 2004 00364

(51) Int. Cl. B32B 27/38; B32B 27/36; B21D 39/03

(52) U.S. Cl. 428/418; 428/480; 29/428

(57) ABSTRACT

For preventing or reducing temperature gradient caused bending of a structural element made of a material capable of withstanding heating to a specific temperature for an extended period of time, when heating the element to the specific temperature, the structural element is connected to an adjacent supporting structural element through a high temperature resistant supporting body. The structural element, providing the high temperature resistant supporting body is provided as a pultruded profiled body including a solidified high temperature resistant resin and reinforcing fibers at least a part of which are constituted by fibers exhibiting high strength and high stiffness at a low temperature and a reduced strength and a reduced stiffness when exposed to and possibly deteriorated at the specific temperature. The structural element is fixated relative to its supporting structure by means of the pultruded body.

The present invention relates to novel techniques of preventing or reducing temperature gradient caused bending of structural elements which may be exposed to a high temperature such as a temperature caused by a fire at the one side of the structural elements.

A number of structural or building systems exists such as house buildings, including horizontal divisions, doors, windows, fire shieldings, structures of ships, including deck divisions, divisions between shutters, doors, windows and fire shieldings, etc. which serve the purpose of physically separating the one side of the structural element or elements from the opposite side and for preventing that a fire, provided that a fire should occur on the one side of the structural element or elements, be transmitted to the other side of the element or elements. Conventionally, structural elements of this kind are built from steel or include a steel component which is fixated to a supporting structure or another structural element by means of a high temperature resistant and thermal insulating elements such as a high temperature resistant pultruded body, i.e. a body made from a high temperature resistant resin and including high strength and high stiffness fibres such as glass fibres, carbon fibres, kevlar fibres, etc. The high temperature resistant body made from e.g. epoxy, phenol, fire retarded polyester resin and including glass fibres may stand exposure to temperatures above 1000° C. and have been used extensively within the field of fire-resistant structures, such as fire-resistant doors and the like. Examples of fire-resistant doors per se are described in U.S. Pat. No. 6,434,899, U.S. Pat. No. 6,615,544, U.S. Pat. No. 4,811,538, U.S. Pat. No. 4,364,987 and GB 8630463 and reference is made to these US patents which are further incorporated in the present specification by reference.

A modern fire-resistant structure may include a high temperature resistant pultruded body which separates the two sides of the fire-resistant structure from one another as the one side being made from steel, aluminium or similar high temperature resistant metal material is fixated to one flange part of the high temperature resistant pultruded body and the other side also being made from steel or another high temperature resistant metallic material is fixated to another flange part of the high temperature resistant body. The interior of the fire-resistant structure is conventionally filled with a filling of thermal insulating and high temperature resistant materials such as fibres made from rock, glass or similar material.

The structural elements of the above kind such as a fire-resistant door may be constructed for withstanding exposure to heat of a temperature of 1000° C. for an extended period of time such as 1 hour and at the same time the structural elements should prevent the fire from being transmitted from the one side of the structural elements to the other side of the structural elements. A problem may occur as the one side of e.g. a door, viz. the side facing the fire, is heated to the temperature of the fire such as a temperature of 1000° C. or even more and the opposite side is to be kept at a fairly low temperature such as a temperature below 40°-50° C. Consequently, as will be understood, a high temperature gradient exists across the structural element or elements, and the temperature gradient causes the two sides of the structural elements, e.g. the two parts of the door, viz. the one part facing the high temperature fire and the opposite side facing the low temperature side to expand differently as the high temperature side expands and thereby may give origin to a temperature gradient caused bending of the door leaf. The temperature gradient caused bending of e.g. a fire-resistant door causes the door leaf to be bent and consequently, in the extreme situation, the door leaf is delocated and therefore may provide minor openings through which the fire may be transmitted from the high temperature fire side to the cold side past the fire-resistant door.

In the present context, the expression ‘temperature gradient caused bending’ is used as a generic term defining the phenomena of causing the structural element or structural elements to be bent due to a high temperature gradient across the structural element or structural elements. The phenomena is similar to the phenomena known from e.g. switches in which a bimetal element is used for causing a temperature dependent bending of the element due to the bimetallic effect when heating the bimetallic element. The phenomena defined as temperature gradient caused bending is in many aspects similar to the bimetallic bending phenomena well-known in the art and the expression ‘temperature gradient caused bending is therefore to be construed as used in the present context as a generic term comprising any phenomena similar to the above-described phenomena and also e.g. the bimetallic bending.

It is contemplated that similar situations as the above described bending of a fire wall may occur provided fire separation or division elements be used such as horizontal divisions, separations or divisions between horizontal flats, doors, windows, fire shieldings, gates, ports, e.g. gates or ports of combustion ovens or furnaces, composites doors made of combined metal and wood structures, structures of ships, including deck divisions, divisions between shutters, doors, windows and fire shieldings, etc. Generally, the present invention is contemplated to be of relevance in relation to composite or combined structures exposed to varying temperature gradients such as temperature gradients of at least 200°-300° C.

It is an object of the present invention to provide a technique of preventing or reducing temperature gradient caused bending of a structural element made of a material capable of withstanding heating to a specific high temperature such as a temperature in the order of 800-1000° C. which structural element may constitute the one side of a fire wall or similar structure.

It is an advantage of the present invention that the separation between structural elements or between a structural element and a supporting structure may be obtained using and utilising the inherent advantages of pultruded bodies as to high strength and high stiffness, low weight, high temperature resistance, etc. and at the same time eliminate or reduce the temperature gradient caused bending of the structural element when exposed to the specific high temperature and consequently without deteriorating the support of the structural element.

The above object, the above advantage together with numerous other objects, advantages and features which will be evident from the below detailed description of the present invention are according to a first aspect of the present invention obtained by a method of preventing or reducing temperature gradient caused bending of a structural element made of a material capable of withstanding heating to a specific temperature for an extended period of time, when heating the element to the specific temperature, the structural element being connected to an adjacent supporting structural element through a high temperature resistant supporting body, comprising the steps of providing the structural element, providing the high temperature resistant supporting body as a pultruded profiled body including a solidified high temperature resistant resin and reinforcing fibres at least a part of which being constituted by fibres exhibiting high strength and high stiffness at a low temperature and a reduced strength and reduced stiffness when exposed to and possibly deteriorated at the specific temperature and fixating the structural element relative to its supporting structure by means of the pultruded body.

According to the basic teachings of the present invention, the structural supporting high temperature resistant pultruded body includes a part of fibres which are not stable at the specific temperature and which are softened or alternatively deteriorated at the specific temperature thereby weakening the supporting pultruded body.

The reinforcing fibres may specifically comprise a first part constituted by high strength, high stiffness and high temperature stable fibres such as glass fibres, carbon fibres, kevlar fibres capable of withstanding heating to the specific high temperature and a second part such as polymer fibres, natural fibres, e.g. polymer fibres made from PE, PP, PVC or similar materials or combinations thereof, or alternatively natural fibres such as fibres made from plants, trees, etc. or fibres made from glass, carbon fibres or similar high strength and high stiffness fibres provided with an outer polymer coating such a PE, PP or PVC coating.

The fibres causing the weakening of the supporting pultruded body, i.e. the above-mentioned second part of the fibres, may be evenly distributed within the resin or alternatively be located at specific zones for establishing a specific weakening zone or a bending zone rather than providing an overall weakening of the supporting pultruded body. The location of the fibres which cause the weakening of the supported body when exposed to the elevated high temperature may further be symmetrical or asymmetrical within the pultruded body as an asymmetrical location may cause one side of the pultruded body to be weakened and thereby causing a one side deformation of the body rather than an overall weakening and a deformation of the pultruded body when exposed to the specific elevated temperature. Provided one or more zones be located within the pultruded supporting body, a central deformation or a central deformation zone may be obtained provided the zones be located at the centre of the pultruded body.

The technique of eliminating or reducing temperature gradient caused bending according to the method according to the first aspect of the present invention may be used in connection with any of the above described structural elements. A particular application of the present invention, however, relates to the elimination of temperature gradient caused bending of fire-resistant doors as discussed above, and consequently, according to a particular aspect and the presently preferred embodiment of the method according to the first aspect of the present invention, the supporting structural element like the structural element itself, constitutes the two metallic plates of a fire-resistant door.

The materials used for the resin of the fire-resistant, pultruded body may be any of the materials conventionally used within the pultrusion industry such as polyester, vinylester, phenol, epoxy or combinations thereof, and also thermoplastic materials used for thermoplastic pultrusion.

The above object, the above advantage together with numerous other objects, advantages and features which will be evident from the below detailed description of the present invention are according to a second aspect of the present invention obtained by a pultruded body comprising a resin body including a solidified high temperature resistant resin and reinforcing fibres at least a part of which being constituted by fibres exhibiting high strength and high stiffness at a low temperature and a reduced strength and a reduced stiffness when exposed to and possibly deteriorated at said specific temperature.

The pultruded body according to the second aspect of the present invention may comprise any of the features as discussed above with reference to the first aspect of the present invention.

Finally, according to a third aspect of the present invention, a method of producing a pultruded body according to the above second aspect of the present invention is provided which method comprises the steps of providing reinforcing fibres at least a part of which being constituted by fibres exhibiting high strength and high stiffness at a low temperature and a reduced strength and reduced stiffness when exposed to and possibly deteriorated at the specific temperature, providing a resin and producing the body from the reinforcing fibres and the resin in a pulltrusion process for providing the pultruded body and curing the pultruded body at a temperature without deteriorating the at least part of the fibres.

Basically, the method of producing the pultruded body according to the second aspect of the present invention and in itself constituting a third aspect of the present invention basically constitutes a conventional pultrusion technique involving the positioning of the fibres characteristic of the present invention exhibiting the feature of providing a high strength, high stiffness and high stable pultruded body at low temperatures such as temperatures below 100° C. and allowing the pultruded fire-resistant body to be bent or otherwise deformed or eliminating or substantially reducing the temperature gradient caused bending by the simple melting of the fibres provided polymer fibres be used or alternatively through deterioration such as through burning or decomposition provided certain polymer fibres or natural fibres be used.

The invention is now to be further described with reference to the drawings in which

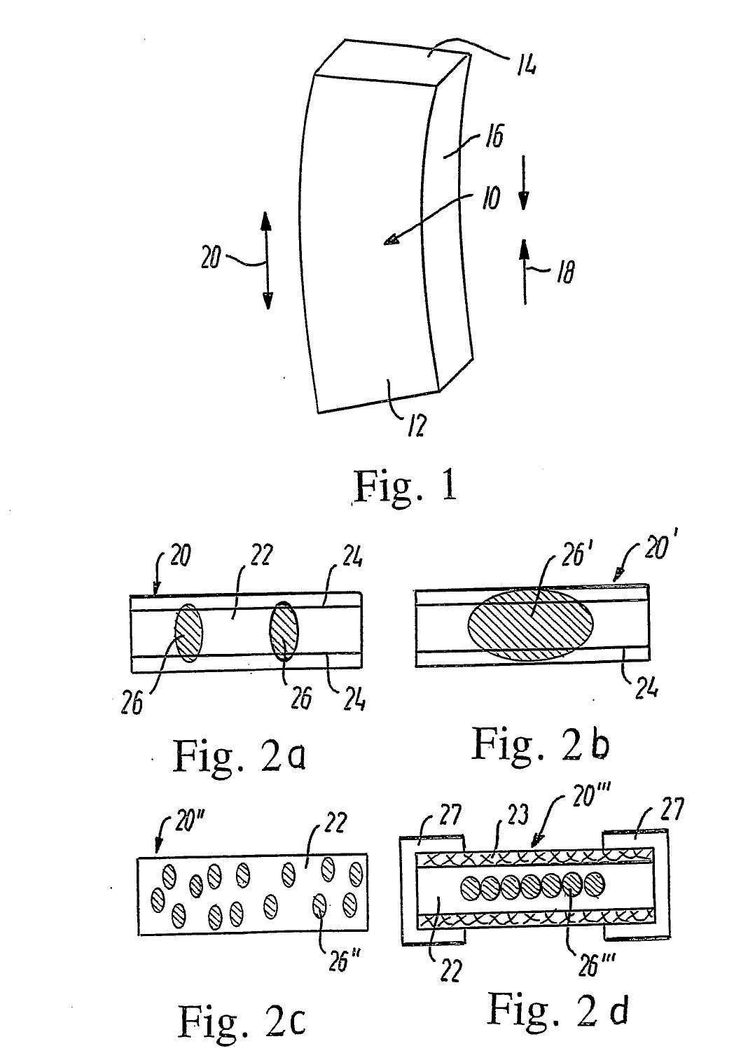

FIG. 1 is a schematic and perspective view illustrating the temperature gradient caused effect of a conventional high temperature resistant and highly stable temperature gradient caused body,

FIGS. 2a, 2b, 2c and 2d are vertical sectional and schematic views illustrating different embodiments of a pultruded body to be used as elements for eliminating or reducing temperature gradient caused bending,

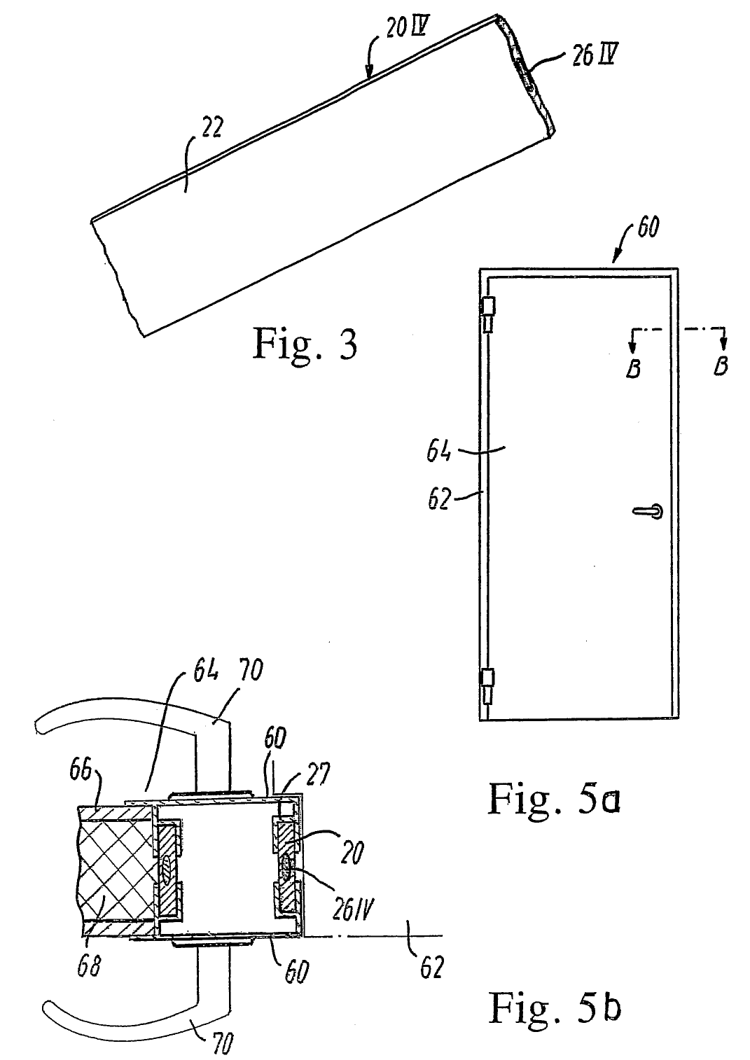

FIG. 3 is a perspective view of a prototype embodiment of a pultruded body according to a specific aspect of the present invention,

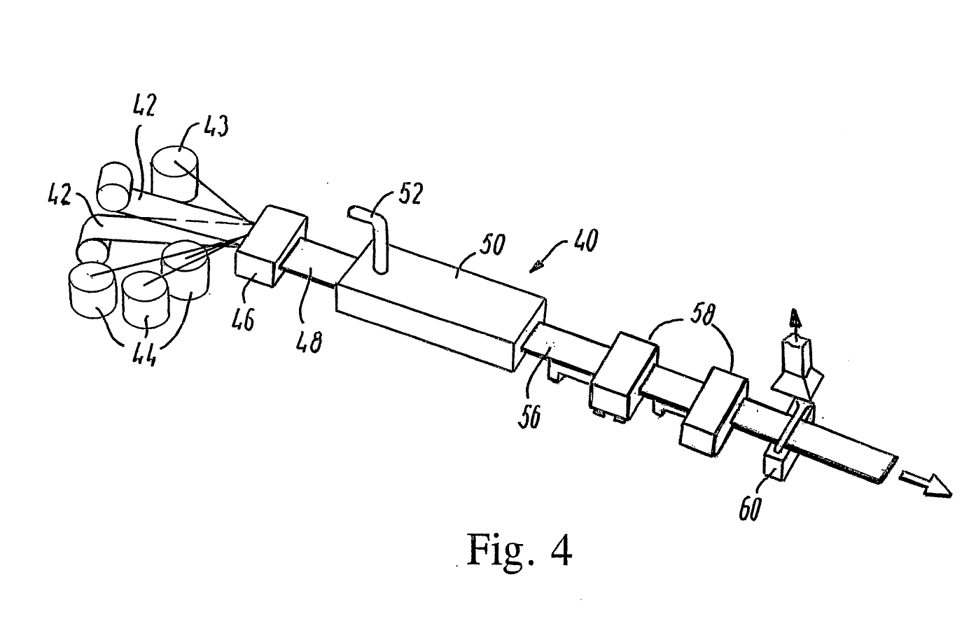

FIG. 4 is a schematic view illustrating a plant for the introduction of the pultruded body according to the present invention as shown in FIG. 3, and

FIGS. 5a and 5b are a schematic view of a fire-resistant door and a sectional view of the fire-resistant door, respectively, in which a pultruded supporting body is used as a supporting body for interconnecting the two metallic leaf parts of the fire-resistant door and for eliminating or reducing a metallic bending of the door provided the one side of the door be exposed to extreme heating such as heating to a temperature of approximately 800-1000° C. for an extended period of time such as 1 hour,

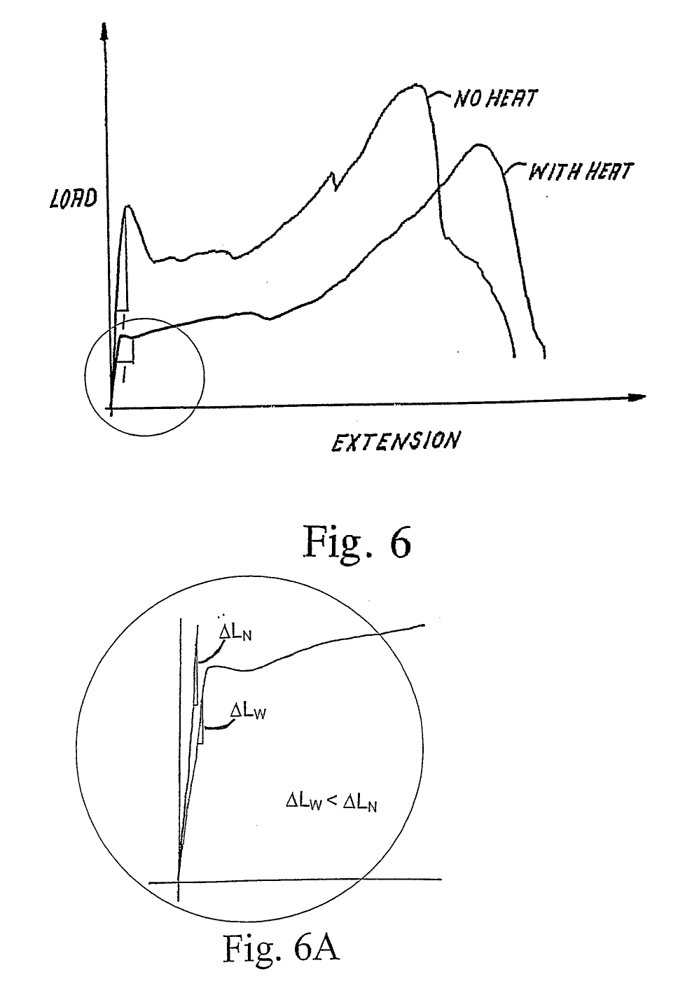

FIG. 6 is a diagrammatic view illustrating the effect of substituting high strength and high stiffness fibres of a pultruded body for allowing the pultruded body to be extended when exposed to heat, and

FIG. 6a is a detail of the diagrammatic view of FIG. 6.

In FIG. 1, a schematic view is shown illustrating the temperature gradient caused bending of a structural element exposed to an extreme heating at the one side of the structural element. The reference numeral 10 designates schematically the structural element having an end wall 12, a top wall 14 and a side wall 16. Opposite to the end wall 12, the structural element 10 has a further end wall and opposite to the top wall 14, the structural element 10 further has a bottom wall and opposite to the side wall 16, the structural element 10 has a further end wall, and opposite to the top wall 14, the structural element further has a bottom wall and opposite to the side wall 16, the structural element 10 has a further side wall which is exposed to an extreme heating such as the heat from a fire causing a raising of the temperature at the side of the structural element 10 opposite to the side wall 16 to e.g. 800°-1000° C. Consequently, the side wall of the structural element 10 opposite to the side wall 16 is caused to expand as indicated by a pair of opposite arrows 20 whereas the side wall 16 is contracted or relative to the expanded side wall diminished. This effect of bending the side wall 16 or actually the structural element 10 is called temperature gradient caused bending and may in an extreme situation cause the structural element to provide gaps along the top and bottom walls thereby deteriorating the intentional function of preventing the fire from spreading from the hot side, i.e. the left hand part of FIG. 1 to the cold side, i.e. the right hand part of FIG. 1.

For preventing the temperature gradient caused bending of the structural element 10, the thermal insulating and structural supporting elements of the structural element according to the teachings of the present invention provided with certain zones which are weakened when exposed to the extreme heating such as a heating to a temperature of 800°-1000° C. In a conventional fire-resistant structural element, e.g. a door or a wall, the two metallic faces constituting the side walls of the fire-resistant structural element are interconnected by a non-thermal transmitting or heat insulating pultruded body serving to reduce the thermal transmission of heat from the hot side to the cold side. As a conventional high strength, high stiffness and high temperature resistant pultruded body includes solid glass fibres, carbon fibres or kevlar fibres, the pultruded body maintains its high strength and high stiffness even at the extreme temperatures to which the body may be exposed when included in a fire-resistant the structural element which is exposed to fire at the one side such as a heating to a temperature of 800°-1000° C. In order to allow the two metallic leaves or walls of the structural element to be shifted relative to one another and consequently eliminating or to a substantial extent reducing the temperature gradient caused bending of the fire-resistant structural element, the thermal insulating and supporting pultruded body of the fire-resistant wall is according to the teachings of the present invention constituted by a pultruded, profiled body which includes apart from the high strength, high stiffness and high thermal stable glass fibres, carbon or kevlar fibres, fibres such as polymer fibres and natural fibres which are melted or deteriorated when exposed to the extreme high temperature of e.g. 800°-1000° C.

Throughout the various figures, elements or components, serving the purpose as elements or components respectively described above, however, having a different geometrical configuration are designated the same reference numerals, however added a marking for identifying the geometrical difference. As indicated in FIGS. 2a-2d, the meltable or deterioratable fibres may be positioned in certain zones as in FIG. 2a a profiled pultruded body 20 includes a resin core 22 in which strips of reinforcing webs or reinforcing fibres 24 are included together with two zones 26 including polymer or natural fibres and providing a weakening of the profiled body 20 in these specific zones provided the profiled body 20 be heated a temperature above the melting point or alternatively the decomposition of burning temperature of the fibres included in the two zones. The provision of the zones may be changed for obtaining a specific bending capability as is illustrated in the embodiments 2a-2d.

In FIG. 2b, the profiled pultruded body 20′ includes a major central zone 26′ in which a large amount of polymer fibres or similar fibres providing weakening within the zone 26′ provided the profiled pultruded body 20 be exposed to a temperature above the melting point of the polymer fibres.

In FIG. 2c, a multitude of zones 26 are provided within the resin 22 of the profiled, pultruded bode 20″ and at the same time, the reinforcing webs or fibres 24 are omitted. In FIG. 2d, a further elaborated structure is shown as the profiled pultruded body 20′″ includes the resin core 22 in which three weakening zones 26′″ are provided. As a sandwich enclosing the resin core 22, two layers 23 are provided. The layers 23 may include a high amount of high strength, high stiffness and high temperature stable fibres, such as glass fibres, carbon fibres or kevlar fibres and furthermore, the profiled pulltruded body 20′″ includes two end profiled parts 27 enclosing the outer ends of the shallow body composed of the two sandwiching layers 23 and the central resin core 22. The element 27 may be made from resin material or alternatively be constituted by metallic end caps which are machined to the profiled pultruded body 20′″ after the completion of the pultrusion process.

In FIG. 3, a perspective view of a profiled pultruded body according to the present invention is shown including a glass fibre reinforced resin 22 encircling a central weakening zone 26^{IV}.

In FIG. 4 a pulltrusion apparatus 40 is shown comprising a receiving section 46 in which webs of fibre reinforcing materials are introduced which webs are shown in the left-hand part of FIG. 4 and two of which are designated the reference numeral 42. In FIG. 4, the reference numeral 44 designates three supplies of high strength, high stiffness and high temperature stable fibres such as glass fibres, carbon fibres or kevlar fibres which are also introduced into the receiving section 46 of pultrusion apparatus 40. Apart from the high strength, high stiffness and high temperature stable supplied from the supplies 44, reinforcing fibres such as polymer fibres or natural fibres are further supplied to the receiving section 46 from a reservoir 43 shown in the top part of FIG. 4 which fibres serve as reinforcing fibres and provide high strength and high stiffness at a low temperature such as a temperature below 100° C. and which fibres are melted or deteriorated when exposed to an elevated temperature such as a temperature of 900°-1000° C. From the receiving section 46, a string 48, including the webs 42, the high strength, high stiffness and high temperature stable fibres from the supplies 44 and further the fibres supplied from the reservoir 43 are introduced into a resin applicator and resin heating and curing apparatus 50 communicating with a resin reservoir through a pipe 52 for the supply of resin thereto. An output die of the apparatus 50 is designated the reference numeral 54 and provides a specific configurated shaping of the of a pulltrusion string 56 delivered from the apparatus 50 which string 56 is introduced into two puller apparatuses 58 for pulling the pulltrusion string from the die 54 of the apparatus 50. From the puller 58, the string 56 is delivered to a cutter 60 which separates the string 56 into distinct sections.

In FIG. 5a, a fire-resistant door 60 is shown comprising a frame 62 and a door leaf 64. The door leaf 64 is manufactured in accordance with the teachings of the present invention, and in FIG. 5b, a sectional view of the door leaf 64 and the frame discloses these structures of the door, in particular door leaf.

In FIG. 5b, the pultruded body 20^{IV} is shown having two end caps 27 to which two metallic door leaves 66 are welded or fixated e.g. by means of rivets or other mechanical fixation elements. The fire-resistant door 60 also includes a central heat insulating filling 68 enclosed between the two metallic leaves 66. The fire-resistant door 60 further includes a pair of handles 70 having a through-going shaft not shown in the drawing.

In FIG. 6, two graphs are shown, each illustrating the extension of the profiled pultruded body according to the present invention such as the body 20^{IV} shown in FIG. 3 when exposed to a load and when not heated and when heated, respectively. The one graph designated ‘no heat’ represents the extension of the profiled pultruded body when not exposed to heating, and the other graph designated ‘with heat’ represents the extension of the profiled pultruded body when exposed to heat such as heating to a temperature of above 500° C. As is evident from FIG. 6, the profiled pultruded body is allowed to extend to a higher degree when heated, thereby allowing the structural element including the profiled pultruded body to minimise or eliminate temperature gradient caused bending of the structural element. When heated, the structural body has a lower shear modulus which allows the structural body to elongate more freely due to the heating thus minimising the temperature gradient caused bending of the structural element.

In FIG. 6a a detail of the diagrammatic view of FIG. 6 is shown illustrating in greater details the first part of the two curves shown in FIG. 6. The detail of FIG. 6a shows that the ‘no-heat’ graph is steeper than the ‘with-heat’ graph, and also shows that the ‘no-heat’ graph is positioned above the ‘with-heat’ graph.

### EXAMPLE

A prototype embodiment of the profiled pultruded body 20^{IV} shown in FIG. 3 is made from the following components: The resin was phenol, the high strength, high stiffness and high temperature stable fibres were glass fibres, the bending zone generating fibres were polymer fibres of polyester. The profiles measured: 31 mm width, 50 mm height and 2,6 mm thickness. The prototype version of the profiled pultruded body 20^{IV} was used for the measurements illustrated in FIG. 6.

1. A method of preventing or reducing temperature gradient caused bending of a structural element made of a material capable of withstanding heating to a specific temperature for an extended period of time, when heating said element to said specific temperature, said structural element being connected to an adjacent supporting structure through a high temperature resistant supporting body, the method comprising:
providing said structural element with the high temperature resistant supporting body as a pultruded profiled body, the supporting body having a solidified high temperature resistant resin and reinforcing fibers, wherein at least a part of the reinforcing fibers constitutes fibers exhibiting high strength and high stiffness at a low temperature and a reduced strength and a reduced stiffness when exposed to said specific temperatures
and fixating said structural element relative to its supporting structure by means of said pultruded body.

2. (canceled)

3. The method according to claim 1, said structural element being a metallic plate of a fire-resistant door.

4. The method according to claim 1, wherein said reinforcing fibers include a first group of fibers selected from the group consisting of at least one of glass fibers, carbon fibers, and KEVLAR fibers capable of withstanding heating to said specific temperature; and a second group of fibers selected from the group consisting of at least one of polymer fibers, natural fibers, and combinations thereof, and glass fibers having an exterior coating of polymer non-capable of withstanding heating to said specific temperature.

5. The method according to claim 1, said specific temperature being in the range of 300-1000° C.

6. The method according to claim 1, said resin body being made from a material selected from the group consisting of polyester, vinylester, phenol, epoxy and combinations thereof.

7. The method according to claim 1, said pultruded body including one or more zones having at least part of said fibers for allowing the deformation of said pultruded body at said specific zones.

8. A pultruded body for use according to the method of claim 1, said pultruded body comprising a resin body including a solidified high temperature resistant resin and reinforcing fibres at least a part of which being constituted by fibres exhibiting high strength and high stiffness at a low temperature and a reduced strength and a reduced stiffness when exposed to said specific temperature.

9. The pultruded body according to claim 8, said reinforcing fibers comprising a first part including fibers selected from the group consisting of at least one of glass fibers, carbon fibers and KEVLAR fibers capable of withstanding heating to said specific temperature, and a second part non-capable of withstanding heating to said specific temperature consisting of including fibers selected from the group consisting of at least one of polymer fibers, natural fibers, glass fibers, carbon fibers, and KEVLAR fibers having an exterior coating of polymer non-capable of withstanding heating to said specific temperature.

10. The pultruded body according to claim 8, said pultruded body including one or more zones having at least part of said fibers for allowing the deformation of said pultruded body at said specific zones.

11. The pultruded body according to claim 10, said one or more zones being located at the center of said pultruded body for providing a central deformation zone.

12. The pultruded body according to claim 8, said pultruded body being fixated within metal end encasings exposing a central uncovered and insulating central part.

13. The pultruded body according to claim 8, wherein said pultruded body is produced by the steps of providing reinforcing fibers at least a part of which are constituted by fibers exhibiting high strength and high stiffness at a low temperature and a reduced strength and a reduced stiffness when exposed to said specific temperature;
providing a resin and producing said body from said reinforcing fibers and said resin in a pultrusion process for providing said pultruded body; and
curing said pultruded body at a temperature without deteriorating said at least part of said.

14. A method of preventing or reducing temperature gradient caused bending of a structural element capable of withstanding heating to a specific temperature for an extended period of time, comprising:
providing the structural element with a second supporting structural element through a high temperature resistant supporting body, said supporting body being a pultruded profiled body having a solidified high temperature resin and reinforcing fibers, wherein at least part of the reinforced fibers comprises fibers exhibiting high strength and high stiffness at a low temperature and a reduced strength and reduced stiffness at higher temperatures between 300° C.-1000° C.; and
fixating the structural element relative to the second supporting structural element by means of pultruded body.
